(19) United States
(12) Patent Application Publication
(10) Pub. No.: US 2004/0105207 A1
(43) Pub. Date: Jun. 3, 2004

(54) Via programmable gate array interconnect architecture

(75) Inventors: Dieter Spaderna, Campbell, CA (US); Dale Wong, San Francisco, CA (US)

Correspondence Address: RITTER, LANG & KAPLAN, 12930 SARATOGA AE. SUITE D1, SARATOGA, CA, 95070, US

(73) Assignee: LEOPARD LOGIC, INC., CUPERTINO, CA

(21) Appl. No.: 10/637,749

(22) Filed: Aug. 8, 2003

Related U.S. Application Data
(60) Provisional application No. 60/402,308, filed on Aug. 9, 2002.

(51) Int. Cl. H01H 73/00

(52) U.S. Cl. 361/115

(57) ABSTRACT

A segmentation architecture for wiring segments which provides interconnections for a gate array integrated circuit is described. Programming is provided by selectable vias between wiring segments and to the semiconductor substrate surface. The wiring segments of two interconnection layers are arranged in two directions and a programmable buffer can drive signals in a selectable direction depending upon how the via contacts are made to the buffer by the wiring segments carrying the buffer signals.

### CROSS REFERENCE TO RELATED APPLICATIONS

The present application claims priority from U.S. Provisional Patent Application No. 60/402,308, filed Aug. 9, 2002, which is incorporated herein by reference in its entirety.

### BACKGROUND OF THE INVENTION

The present invention is related to the interconnect layers of integrated circuit and, more particularly, to the interconnect layers of via programmable gate arrays (VPGAs).

A conventional programmable gate array is an integrated circuit (or portion of an integrated circuit) in which elements of the circuit are defined as array of logic cells or gates by the manufacturer. The wire interconnections which define the functions of the logic cells and the wire interconnections between the logic cells or gates are defined by the user. Until the user's interconnections are made, the array of logic cells or gates is uncommitted and devoid of functionality. Structurally, the manufacturer defines the circuit elements, such as transistors, in the semiconductor substrate and the user defines, or programs, all the interconnect layers (typically the metal wire and via layers) to complete the design of the integrated circuit for the user's application.

The advantage of a programmable gate array is that the user can receive the integrated circuit in a short time compared to the time to fully design, test and manufacture all the circuitry and layers of an integrated circuit for the user's particular application. To effect a rapid turnaround, the manufacturer can carry a stock of partially built programmable gate arrays which can be quickly completed upon the user's definition of the interconnect layers.

A via programmable gate array (VPGA) is an integrated circuit, or a portion of an integrated circuit, with an array of uncommitted logic cells. The functionalities of, and the interconnections between, the logic cells can be customized with custom integrated circuit manufacturing masks for via layers typically between two metal wire interconnect layers. Currently only a single via layer is used for programming, but multiple metal wire interconnect layers which can be customized with multiple layers of vias are contemplated. A distinguishing attribute is that some wire and via interconnect layers and are fixed, while other interconnect via layers can be customized to interconnect the pre-existing wires and circuits in order to effect a desired functionality and interconnection. For simplicity of exposition, this patent describes a single via layer architecture, but it should be understood that the present invention applies to multiple via layer extensions as well.

A major issue in the design of an efficient VPGA is the length and distribution of the existing wires of the metal interconnect layers, commonly referred to as the “segmentation” of the wires. The segmentation is one of the major determinants of the VPGA area, speed, and power. In the drawing below, two simplistic examples of segmentation are illustrated in FIGS. 1A and 1B to help explain wire segmentation problems.

In the first illustrated segmentation of FIG. 1A, all interconnect wires 11-13 are long and horizontally span all the exemplary logic cells 14-17. Three connections are illustrated. Logic cell 14 is connected to logic cell 15; logic cell 16 is connected to logic cell 17; and logic cell 14 is connected to logic cell 17. Appropriate vias 10 to the first horizontal wire 11 implement the connection from the logic cell 14 to the logic cell 15. Similarly, vias 18 to the second horizontal wire 12 connect the logic cell 16 to the logic cell 17. The third horizontal wire 13 with vias 19 connect the logic cell 14 to the logic cell 17. Three existing horizontal wires 11-13 are required to complete all the connections.

In the second illustrated segmentation of FIG. 1B, all interconnect wires 21-24 are short and horizontally span only two logic cells. With this short segmentation, the wire 21 connects the logic cell 14 to the logic cell 15 and the wire 22 connects the logic cell 16 to the logic cell 17. Both interconnect wires 21 and 22 have the same Y coordinate and are said to share the same “track.” The FIG. 1B segmentation only requires two tracks to complete all connections, whereas the segmentation of FIG. 1A requires three tracks. However, in order to complete the connection from the logic cell 14 to the logic cell 17, some means must be provided to join the two short wires 23 and 24 in the upper track. This intra-track connection means is depicted in the drawing by a large via 20; the actual implementation of this type of connection according to the present invention is shown in detail below.

These two simple examples illustrate the tradeoffs involved in segmentation design. With fewer tracks, the area and cost of the resulting VPGA is lower. Fewer tracks generally results from using shorter wires. Shorter wires also generally result in lower capacitive loading, and therefore smaller delays and lower power dissipation. However, shorter wires require more wire-to-wire connections, which themselves may add area, delay and power dissipation.

Most prior art segmentation is found in the design of FPGAs (Field Programmable Gate Arrays) which use anti-fuses to program the device. In such integrated circuits, anti-fuses form the programmable connections between two mutually perpendicular interconnect wiring layers. An anti-fuse normally has such a high resistance that it can be considered an open circuit; there is no connection between the two conducting interconnect wiring layers. After the application of a high voltage across the anti-fuse, the resistance drops permanently and sufficiently so that the anti-fuse can be considered a closed circuit; the two conducting layers are connected.

Hence such FPGAs have a fixed pattern, i.e., segmentation, of interconnect wires with a distribution of anti-fuses for programming the devices. The segmentation for the FPGA is constrained by properties particular to anti-fuses. A connected anti-fuse still has a relatively high resistance compared to the conducting metal layers, and therefore each anti-fuse included in a programmable connection adds a significant delay. In addition, the total number of anti-fuses used by a segmentation has an inverse relationship with the manufacturing yield of good semiconductor die. Hence most of anti-fuse segmentation prior art is aimed at reducing the number of programmable connections in the segmentation. The common practice is to design the segmentation with a variety of wire lengths, and then attempt to use short wires for short connections and long wires for long connections. Nonetheless, the most desirable distribution of wire lengths is a black art, and segmentation design relies on techniques such as simulated annealing, Rent's rule, binary distributions, and statistical guesswork.

In addition, a new problem for segmentation arises from shrinking geometries in current semiconductor manufacturing processes. In the so-called Deep Sub-Micron (DSM) manufacturing processes, long interconnect wires must be buffered at certain intervals to reduce overall signal delay and crosstalk effects. This is problematic for a VPGA because a buffer is unidirectional, but VPGA routing wires are usually assumed to be available bi-directionally, and the actual signal direction depends upon how the wire is used in the connection which is programmed by the user. In the FIGS. 1A and 1B examples above, the required connection could have been from the logic cell 17 to the logic cell 14, as well as from the logic cell 13 to the logic cell 17. Buffer circuits add significant area to a semiconductor layout design and signal delay, and therefore must be used judiciously in segmentation design.

The present invention addresses these problems of segmentation, including that of buffers for long interconnect wires. The result is a via programmable gate array with an extremely fine granularity segmentation implemented with an alternating direction wire fabric and a programmable direction buffer.

### SUMMARY OF THE INVENTION

The present invention provides for a programmable gate array which has its functionality for an application determined by vias defined by at least one via layer mask. The programmable gate array has a first interconnection layer having a plurality of wiring segments aligned in a plurality of tracks in a first direction and in a second direction orthogonal to the first direction and a second interconnection layer displaced from the first interconnection layer in a vertical direction orthogonal to the first and second directions. The second interconnection layer has a plurality of wiring segments aligned in the tracks with respect to the plurality of wiring segments of the first interconnection layer. Each end of wiring segments of the first interconnection layer lies under an end of wiring segments of the second interconnection layer. Vias defined by the via layer mask provide interconnections between selected ends of the wiring segments in the first and second interconnection layers. A wiring segment in the first interconnection layer having an end lying under an end of a wiring segment in the second interconnection layer lies in the same track as the second interconnection layer wiring segment.

The present invention also provides for a programmable gate array which has a first interconnection layer with a plurality of wiring segments aligned in a plurality of tracks in a first direction and in a second direction orthogonal to the first direction, a second interconnection layer displaced from the first interconnection layer in a vertical direction orthogonal to the first and second directions. The second interconnection layer has a plurality of wiring segments aligned with respect to said plurality of wiring segments of the first interconnection layer including single wiring segments in the second interconnection layer each having portions displaced in the vertical direction from contiguous wiring segments of the first interconnection layer in the same track. Vias defined by the via layer mask provide interconnections between the contiguous wiring segments in the first interconnection layer in the same track and portions of the single wiring segments in the second interconnection layer whereby the contiguous wiring segments in the first interconnection layer in the same track are interconnected.

The vias defined by the via mask layer can also provide selectable interconnections between the wiring segments of the described interconnect layers and other interconnect layer(s), or even to the surface of the semiconductor substrate of the programmable gate array.

The present invention also provides for a buffer circuit; and first and second wiring segments in an interconnection layer and aligned over the buffer circuit so that via connections from the first and second wiring segments to the buffer circuit determine direction of signals between the first and second wiring segments through the buffer circuit. Furthermore, the first and second wiring segments are aligned in the same track.

### BRIEF DESCRIPTION OF THE DRAWINGS

FIG. 1A is an example of wiring segmentation with three tracks of segments for four logic cells; FIG. 1B is an example of wiring segmentation with two tracks of segments for four logic cells;

FIG. 2 is a top view of two interconnect layers, each with mixed direction wiring segments, according to one embodiment of the present invention;

FIG. 3 is a top view of two interconnect layers, each with mixed direction wiring segments, according to another embodiment of the present invention;

FIG. 4 is a top view of two interconnect layers, each with mixed direction wiring segments, according to still another embodiment of the present invention;

FIG. 5 is a layout view of a conventional buffer circuit;

FIG. 6A is a layout view of a buffer circuit, according to one embodiment of the present invention; FIG. 6B is a layout view of the FIG. 1A buffer circuit with two unconnected wiring segments over the buffer circuit; FIG. 6C is a layout view of the FIG. 6B buffer circuit with connecting vias for the buffer circuit to drive signals in one direction between the two wiring segments; FIG. 6D is a layout view of the FIG. 6B buffer circuit with different connecting vias for the buffer circuit to drive signals in the opposite direction between the two wiring segments; and

FIG. 7 is a representational top view of a LUT and multiplexers which form a programmable logic cell and their via interconnections, according to one embodiment of the present invention.

### DESCRIPTION OF SPECIFIC EMBODIMENTS

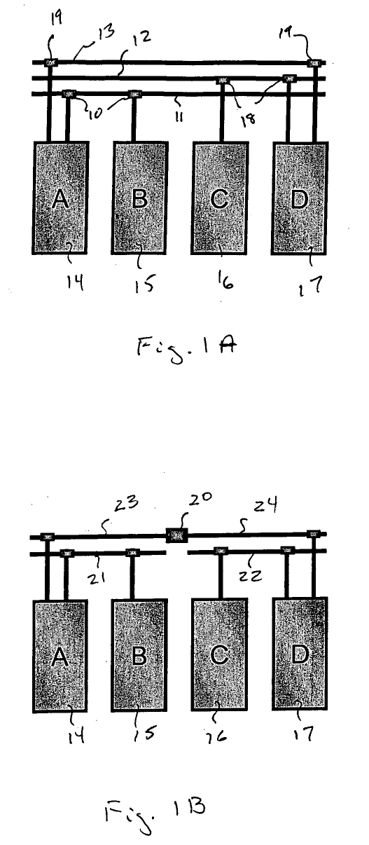

As best known by the inventors, most via and anti-fuse layout designs use a segmentation design which assigns a direction for the wires on a given interconnection routing layer, and an orthogonal direction for adjacent interconnection layers. For example, the wires for the logic cell inputs and outputs can be assigned to metal layer 3 and are predominantly vertical, and the wires for the routing tracks can be assigned to metal layer 4 and are predominantly horizontal. Vias are then used to connect overlapping vertical and horizontal wires. This typical layer assignment is illustrated in FIGS. 1A and 1B.

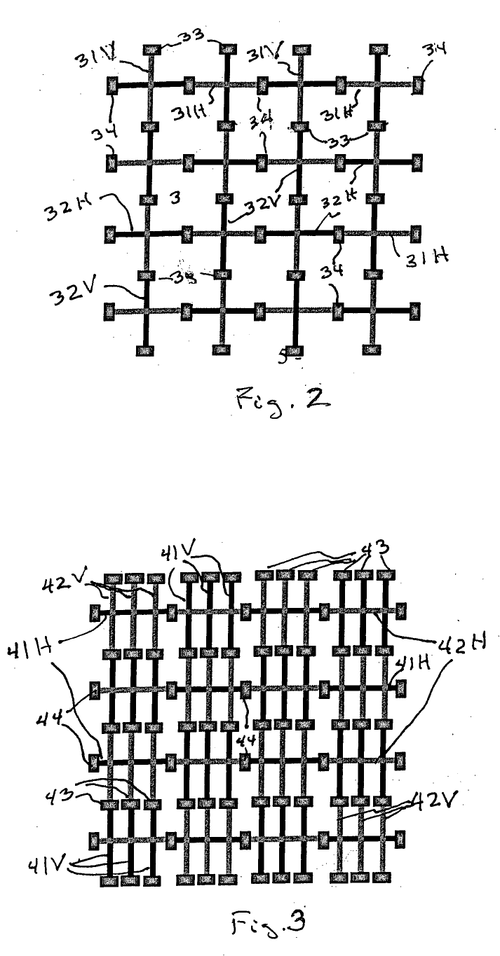

On the other hand, the present invention presents a fine granularity segmentation of the wiring interconnects, which is highly suitable for VPGA. Instead of a predominant direction for each interconnect layer, there are mixed directions in each layer and the wires within the same track alternate layers. In FIG. 2 vias 33 and 34 make the programmable connections between two interconnect layers, say arbitrarily, metal layers 5 and 6, of a semiconductor process. One layer has vertical wiring segments 31V and horizontal wiring segments 31H. The second layer has vertical wiring segments 32V and horizontal wiring segments 32H. The vias 33 provide the programmable connections for the wiring segments in the vertical tracks and the vias 34 provide the programmable connections for the wiring segments in the horizontal tracks. Of course, “vertical” and “horizontal” refer to two mutually orthogonal directions on a semiconductor layout and are used here for the reader's benefit. The resulting segmentation is a wire “fabric;” the tracks appear to be interwoven in the illustrated top view.

The advantage of this mixed direction layer track design is that the simple vias may be used as an intra-track programmable connection for the segmentation. A via occupies very little space and is very simple to implement with a single semiconductor process mask. From a design standpoint, a via provides for a way of making connection with “low overhead.” The via overhead is so low that the all the tracks can be segmented into very short wires and still permit an VPGA which is efficient in terms of area and delay. The present invention ameliorates the need to design a segmentation with a fixed distribution of various wire lengths. In the extreme case with all very short wires, each connection can be implemented with just the required wire length, which increases track utilization, decreases total area, decreases capacitance, decreases delay, and decreases power dissipation.

Another advantage of this mixed direction layer track design is that adjacent wires in the same interconnect layer are further apart, at four times the minimum track pitch, which drastically reduces the crosstalk effects from capacitive coupling between adjacent wires. For example, in FIG. 2 two neighboring vertical wiring segments 31V tracks are spaced apart by the minimum track pitch of: 1) distance between a first vertical wiring segment 31V and a via 34; 2) distance between the via 34 and a vertical wiring segment 32V in the second wiring layer; 3) distance between the vertical wiring segment 32V in the second wiring layer and a second via 34; and 4) distance between the second via 34 and a second vertical wiring segment 31V.

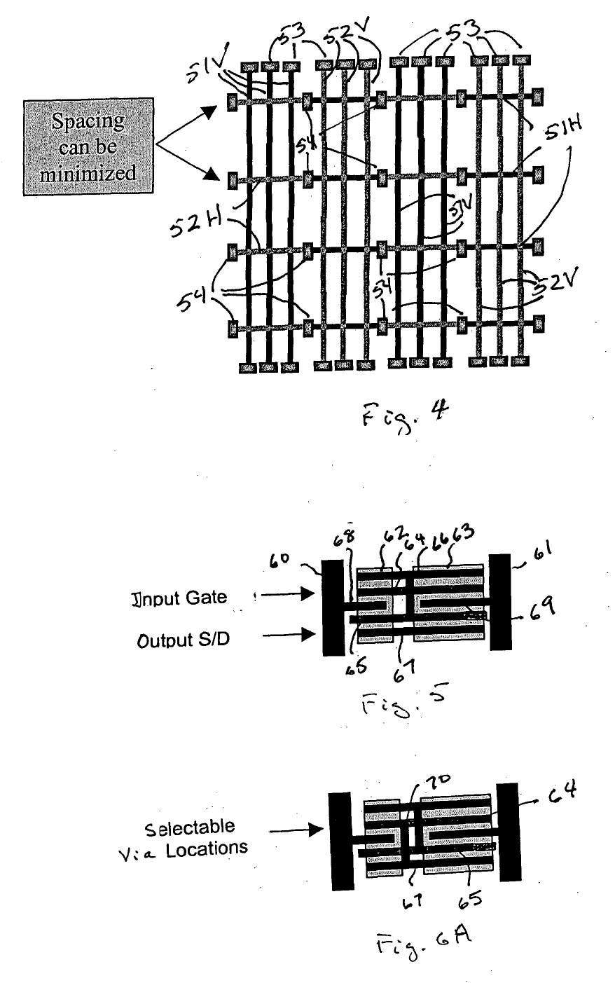

This mixed direction layer track design supports many variations in accordance with the present invention. For example, the number of vertical tracks between horizontal layer changes can be varied. This is illustrated in FIG. 3 in which each interconnection layer has three vertical wiring segments separated by a horizontal wiring segment. One interconnection layer has vertical wiring segments 41V and horizontal wiring segments 41H; the second interconnection layer has vertical wiring segments 42V and horizontal wiring segments 41H. Again, the wiring segments within the same track alternate interconnection layers. Vias 43 provide the programmable interconnections for the wiring segments 41V and 42V in the vertical tracks and vias 44 provide the programmable interconnections for the wiring segments 41H and 42H in the horizontal tracks.

In another variation of the mixed direction layer track design, some of the horizontal track spacing can be decreased by eliminating some of the vertical track vias, i.e., increasing the lengths of the vertical wiring segments, as shown in FIG. 4. One interconnection layer has lengthened vertical wiring segments 51V and horizontal wiring segments 51H; the second interconnection layer has lengthened vertical wiring segments 52V and horizontal wiring segments 52H are increased. Vias 53 provide programmable interconnections between the vertical wiring segments 51V and 52V in the same track and vias 54 provide programmable interconnections between the horizontal wiring segments 51H and 52H in the same track. Without vias 53, the vertical distances separating vias 54 can be minimized, i.e., the distance between horizontal tracks can be minimized.

The present invention also contemplates wiring segments in the two interconnection layers which are not necessarily arranged so that the wiring segments all fall into one track are connected by programmable vias end-to-end. In another wiring arrangement, the wiring segments in one interconnection layer are arranged with respect to the wiring segments in the second interconnection layer so that at least some of the first interconnection layer wiring segments are not in the same track as contiguous second interconnection layer wiring segments in the same track, but can connect the contiguous second interconnection layer wiring segments by a single wiring segment. Two vias, one between a first contiguous wiring segment and the single wiring segment of the first interconnection layer, and a second between the single wiring segment of the first interconnection layer and the second contiguous wiring segment, complete the interconnection between the two contiguous wiring segments, as in the case for the wiring segmentation described with respect to FIGS. 2-4. Hence the present invention has flexibility in the segmentation of the wiring segments.

Hence the present invention provides for segmentation of “fine granularity” with many variations in the particular segmentation pattern.

Another aspect of the present invention is a programmable direction buffer which uses single mask programmability to select which wire connects to the buffer's gate and which wire connects to the buffer's output source/drain region. As a circuit element, two serially-connected inverters create the programmable direction buffer. The wire connected to the gate electrode of the first inverter serves as the input to the buffer, and the wire connected to the source/drain region serves as the output from the buffer. By reversing this wire assignment, the direction of buffer operation is reversed. In contrast to conventional implementations which require two buffers (one for each direction) and some type of programmable means to select which buffer to connect, the present invention has only one buffer.

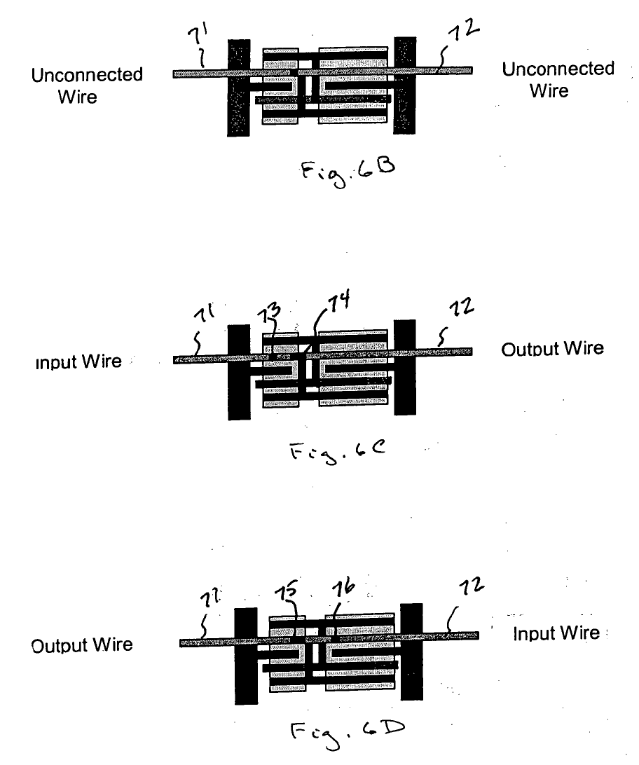

FIG. 5 shows the layout of a conventional buffer which has two inverters in series. Two lines supply power to the buffer circuit, vertical power line 60 for Vdd and vertical power line 61 for Vss (ground). N-type dopant region 62 in the semiconductor substrate forms the source/drain regions of the N-channel transistors of the two inverters. A horizontal wiring interconnect 68 connected to the Vdd power line 60 contacts the middle of the region 62 to provide power to the two N-channel transistors of the buffer. Similarly P-type dopant region 63 in the semiconductor substrate forms the source/drain regions of the P-channel transistors of the two inverters. A wiring interconnect 69 connected to the Vss power line 61 contacts the middle of the region 63 to provide power to the two P-channel transistors of the buffer. An upper horizontal gate electrode 64 which extends across the N-type dopant region 62 provides the gate for the top inverter and a lower horizontal gate electrode 65 which extends across the P-type dopant region 63 provides the gate for the lower inverter of the buffer.

To complete the layout of the buffer, a T-shaped wiring interconnect 66 has a horizontal top portion contacting the N-type source/drain region 62 and the P-type source/drain region 63 above the gate electrode 64. The vertical portion of the wiring interconnect 66 extends downward and passes over the gate electrode 64 to make a contact with the gate electrode 65. A horizontal wiring interconnect 67 below the gate electrode 65 connects the N-type source/drain 62 and the P-type source/drain 63. For the input and output connections to the buffer, a first wiring interconnect (not shown) is connected to the gate electrode 64 by a via and a second wiring interconnect (also not shown) is connected to the source/drain wiring interconnect 67 by a via. In passing, it should be noted that in the description above of the conventional buffer, via connections were not specified because they would understood by integrated circuit designers.

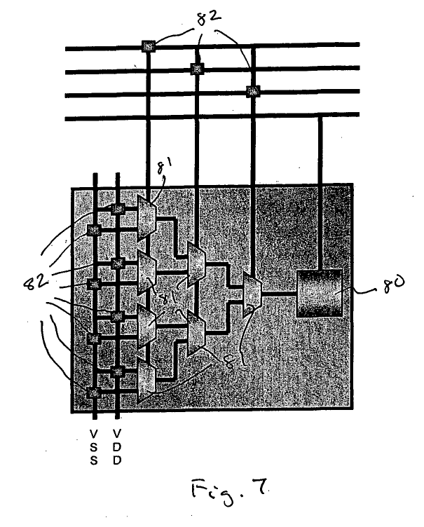

FIGS. 6A-6D illustrate different views of the programmable buffer according to one embodiment of the present invention. The same reference numbers are used where the referenced elements are identical or substantially the same as the elements of FIG. 5 for ease of explanation.

FIG. 6A illustrates an extension to the wiring interconnect 67, an inverted L-shaped extension 70 which passes over the gate electrode 65 to terminate over the gate electrode 64 in the base of the L. The wiring interconnect extension 70 does not contact the gate electrode 64. FIG. 6B illustrates the horizontal wiring segments 71 and 72 of the VPGA. The wiring segments 71 and 72 are in the horizontal track of the gate electrode 64 and are separated over the base portion of the extension 70. The direction of the buffer is created by vias for the wiring segments 71 and 72 to the buffer elements below.

FIG. 6C shows the vias to configure wiring segment 71 as the input to the buffer and the wiring segment 72 as the output from the buffer. A via 73 connects the wiring segment 71 to the gate electrode 64 below and a via 74 connects the wiring segment 72 to the base of the extension 70 so that the segment 72 is connected to the source/drain regions 62 and 63 below the gate electrode 65.

FIG. 6D illustrates the vias to configure the wiring segment 71 as the output and wiring segment 72 as the input of the buffer. The wiring segments 71 and 72 are programmed such that the buffer drives signals in the opposite direction compared to FIG. 6C. A via 75 connects the wiring segment 71 to the base of the extension 70 so that the segment 71 is now connected to the source/drain regions 62 and 63 below the gate electrode 65 and a via 76 connects the wiring segment 72 to the gate electrode 64 below.

An advantage of the described buffer is that only one space-occupying buffer is required to drive signals in either direction. Another advantage of the described programmable buffer is that if both wiring segments 71 and 72 are left disconnected, the track over the gate electrode 64 is segmented; even the “do nothing” state is a programming state for segmenting the track. There are two electrically independent wiring segments which may be used for two separate connections or, alternatively, only one segment may be used for an interconnection and the second segment may be left unused, thereby reducing the capacitive load on the first interconnection.

In the VPGA of the present invention, the programmable buffers are set on long wiring segments. Typically, in a conventional segmentation with a fixed distribution of wire lengths, the scarcest resources are the long wire segments because the distribution is usually designed so that the long wires serve as a catch-all for the connections that cannot be served by shorter wires. As such, the long wire segments are usually poorly utilized because they are much longer than the minimum length required to complete the connection. The result is that frequently there are not enough long wires available to complete all the connections of the user's application. In contrast, the programmable segmentation of the present invention allows the lengths of the long wires to be customized and the utilization of the long wire tracks is improved.

Finally, it should be noted that the selectable vias which create the programmability of the described integrated circuit may also be provide selectable interconnections between the wiring segments of the interconnect layers described with respect to FIGS. 2-4 and other interconnect layers, or the semiconductor substrate surface for the integrated circuit. Such via interconnections were implied by the above description of the programmable buffer circuit of the present invention. With respect to the buffer configuration of FIG. 6C, the via 73 connects the wiring segment 71 to the gate electrode 64 and the via 74 connects the wiring segment 72 to the extension 70.

Another example of interconnections between the wiring segments of the interconnect layers described with respect to FIGS. 2-4 and other interconnection layers is the interconnection of general purpose Look Up Tables (LUTs) and multiplexers are used for many of the logic cells of the VPGA in one embodiment of the present invention. As shown in FIG. 7, for programmable logic functions, a general purpose Look Up Table (LUT) 80 is implemented by configuring via 82 connections for the select lines for multiplexers 81 to either an wiring segment at Vdd, logic “1”, or another wiring segment at Vss, logic “0”, to implement the logical truth table for the function inputs. The interconnections to logic “1” and “0” wiring segments are also made by selectable vias 82. The multiplexers 81 select the appropriate entry in the truth table for the given input values. For the programmable interconnect, a network of existing routing wires potentially connect the outputs of the LUT 80 to the inputs of the LUTs or other logic cells by including one or more vias between the appropriate existing wires so that a continuous conducting path is formed from the function output to the function input.

An alternative interconnection for the LUTs and multiplexers might be the provision of contact areas in the semiconductor substrate surface in which the active elements, i.e., transistors, of the circuits for the LUTs and multiplexers are created. The contact areas provide locations were via contacts may be made for direct interconnections to the wiring segments of the interconnect layers above.

Hence with the fine granularity segmentation of the present invention, multiple intra-track programmable connections can be made. The actual choice is based on circuit design and process parameters, and varies between different manufacturing processes. The relatively costly bi-directional buffer is only used in tracks designed to support long connections and the lower overhead via is used to create relatively short segments in all other tracks. This greatly reduces the segmentation design complexity. Rather than designing a fixed distribution for all possible wire lengths, the optimal length for a buffered wire is determined with circuit analysis. The number of tracks required for connections equal to, or longer than, the optimal buffered length and the number of tracks required for connections shorter than the optimal buffered length are determined.

Although the present invention has been described in accordance with the embodiments shown, one of ordinary skill in the art will readily recognize that there could be variations made to the embodiments without departing from the scope of the present invention. Accordingly, it is intended that all matter contained in the above description and shown in the accompanying drawings shall be interpreted as illustrative and not in a limiting sense.

1. A programmable gate array having functionality for an application determined by vias defined by at least one via layer mask, said programmable gate array comprising
a first interconnection layer having a plurality of wiring segments aligned in a plurality of tracks in a first direction and in a second direction orthogonal to said first direction,
a second interconnection layer displaced from said first interconnection layer in a vertical direction orthogonal to said first and second directions, said second interconnection layer having a plurality of wiring segments aligned in said tracks with respect to said plurality of wiring segments of said first interconnection layer so that each end of wiring segments of said first interconnection layer is displaced in said vertical direction from an end of wiring segments of said second interconnection layer; and
vias defined by said via layer mask providing interconnections between selected ends of said wiring segments in said first and second interconnection layers.

2. The programmable gate array of claim 1 wherein a wiring segment in said second interconnection layer has a first end displaced in said vertical direction from an end of a first wiring segment in said first interconnection layer and lying in the same track as said first wiring segment in said first interconnection layer.

3. The programmable gate array of claim 2 wherein said wiring segment in said second interconnection layer has a second end displaced in said vertical direction from an end of a second wiring segment in said first interconnection layer lying in said same track as said first wiring segment in said first interconnection layer.

4. The programmable gate array of claim 3 wherein said wiring segment in said second interconnection is interconnected at said first end to said first wiring segment in said first interconnection layer by a first via and is interconnected at said second end to said second wiring segment in said first interconnection layer by a second via.

5. The programmable gate array of claim 4 wherein said first wiring segment in said first interconnection layer is connected to a wiring segment in a third interconnection layer by one more vias.

6. The programmable gate array of claim 4 wherein said programmable gate array further comprises
a semiconductor substrate having a surface having logic cells defined thereon, each logic cell having a substrate surface contact area; and
wherein said first wiring segment in said first interconnection layer is connected to a substrate surface contact area by one or more vias.

7. The programmable gate array of claim 1 wherein said wiring segments of said first and second interconnection layers are arrayed in first and second directions and aligned in alternating directions.

8. The programmable gate array of claim 1 wherein said wiring segments of said first and second interconnection layers are arrayed in groups of wiring segments aligned in first direction alternating with at least one wiring segment aligned in said second direction.

9. The programmable gate array of claim 8 wherein said groups of wiring segments in first direction have a length greater than a length of said at least one wiring segment in said second direction.

10. The programmable gate array of claim 9 wherein at least one wiring segment in said second direction comprises a plurality of wiring segments in said second direction.

11. The programmable gate array of claim 1 further comprising
a buffer circuit;
first and second wiring segments in an interconnection layer and aligned over said buffer circuit so that via connections from said first and second wiring segments to said buffer circuit determine direction of signals between said first and second wiring segments through said buffer circuit.

12. The programmable gate array of claim 11 wherein said first and second wiring segments are aligned in the same track.

13. A programmable gate array having functionality for an application determined by vias defined by at least one via layer mask, said programmable gate array comprising
a first interconnection layer having a plurality of wiring segments aligned in a plurality of tracks in a first direction and in a second direction orthogonal to said first direction,
a second interconnection layer displaced from said first interconnection layer in a vertical direction orthogonal to said first and second directions, said second interconnection layer having a plurality of wiring segments aligned with respect to said plurality of wiring segments of said first interconnection layer including single wiring segments in said second interconnection layer each having portions displaced in said vertical direction from contiguous wiring segments of said first interconnection layer in the same track; and
vias defined by said via layer mask providing interconnections between contiguous wiring segments in said first interconnection layer in the same track and portions of said single wiring segments in said second interconnection layer whereby said contiguous wiring segments in said first interconnection layer in the same track are interconnected.

14. The programmable gate array of claim 13 wherein at least one of said contiguous wiring segments in said first interconnection layer is connected to a wiring segment in a third interconnection layer by one or more vias.

15. The programmable gate array of claim 13 wherein said programmable gate array further comprises
a semiconductor substrate having a surface having logic cells defined thereon, each logic cell having a substrate surface contact area; and
wherein at least one of said contiguous wiring segment in said first interconnection layer is connected to a substrate surface contact area by one or more vias.

16. The programmable gate array of claim 13 further comprising
a buffer circuit;
first and second wiring segments in one of said first and second interconnection layers and aligned over said buffer circuit so that via connections from said first and second wiring segments to said buffer circuit determine direction of signals between said first and second wiring segments through said buffer circuit.

17. The programmable gate array of claim 16 wherein said first and second wiring segments are aligned in the same track.
